(19) United States
(12) Patent Application Publication
(10) Pub. No.: US 2004/0134073 A1
(43) Pub. Date: Jul. 15, 2004

(54) Manual cable cutter

(76) Inventor: Minoru Kochi, Sanjo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/409,168

(22) Filed: Apr. 9, 2003

(30) Foreign Application Priority Data
Jan. 14, 2003 (JP) 2003-005329

(51) Int. Cl. B26D 3/16

(52) U.S. Cl. 30/92; 30/249; 30/250

(57) ABSTRACT

A manual cable cutter includes a pair of handles linked to each other in upper parts thereof with two frame plates, one of the pair of handles being adapted as a stationary handle and the other as a rocking handle; a stationary cutting blade having a basal terminal part fixed, with soft bolts capable of being sheared, onto one of the two frame plates in a state superposed on the one frame plate; a rotary cutting blade furnished on an arcuate outer surface thereof with a continuously formed toothed part and pivotally supported rotatably on the stationary cutting blade; a first energizing spring and a second energizing spring disposed between the two frame plates; and a backstop claw meshed with the toothed part of the rotary cutting blade under pressure of the first energizing spring, and a feed claw meshed with the toothed part of the rotary cutting blade under pressure of the second energizing spring and disposed in an upper part of the rocking handle, the backstop claw and the feed claw both being disposed in an empty space defined between the two frame plates

### BACKGROUND OF THE INVENTION

1. Field of the Invention

This invention relates to a manual cable cutter which serves the purpose of cutting various metal cables, such as wires, cables, electric wires, communication lines and reinforcing bars.

2. Description of Related Art

The conventional cable cutters of this class, as disclosed in JP-A HEI 04-236977 though not illustrated concretely herein, share a common construction which comprises a pair of handles linked to each other in the upper part sides thereof and energized in the diverging directions by the action of a spring, one of the two handles being adapted as a stationary handle and the other as a rocking handle, a stationary cutting blade directly fixed at the basal terminal part thereof in the upper part of the stationary handle, a rotary cutting blade furnished on the arcuate outer surface thereof with a continuously formed toothed part and pivotally supported rotatably at the basal terminal part thereof on the leading terminal part of the stationary cutting blade, a backstop claw rotatably disposed in the upper part thereof, the backstop claw being meshed with the outer toothed part of the rotary cutting blade under the pressure of an energizing spring, and a feed claw supported rotatably in the upper part of the rocking handle, and the feed claw being meshed with the outer toothed part of the rotary cutting blade similarly under the pressure of another energizing spring.

The actual use of such a conventional cable cutter is accomplished by a procedure which comprises inserting a cable as a blank in an empty space defined by the rotary cutting blade and the stationary cutting blade which are jointly held in an open state, then guiding the free terminal part of the rotary cutting blade around the pivot as a fulcrum till the outer periphery of the cable is encompassed with the rotary cutting blade and the stationary cutting blade, subsequently causing an operator to take hold of the pair of handles and continuously open and close the rocking handle relative to the stationary handle and, in consequence of the generation of an idle slide and a pushing motion by the feed claw meshed with the outer toothed part of the rotary cutting blade each time the rocking handle is opened and closed, enabling the rotary cutting blade to continue a rotary motion automatically till the empty space is nullified, with the result that the cable will be cut by a blade part formed with the opposed lateral edges of the rotary cutting blade and the stationary cutting blade. Incidentally, during this process, the backstop claw like the feed claw is enabled to prevent the rotary cutting blade from rotating backward by virtue of the idle slide and the pushing motion exerted on the outer toothed part of the rotary cutting blade.

In the conventional manual cable cutter, the basal terminal part of the stationary cutting blade is fixed in situ above the stationary handle through ordinary rigid bolts and nuts. When a cable given to be cut possesses such rigidity as defies the cutting ability of the cable cutter itself, the cable is not cut and the rotary cutting blade is mechanically compelled by the pushing motion of the feed claw to produce a rotary motion and, consequently, the stationary cutting blade is strongly pressed by the cable toward the rear side thereof. If this state continues, it will often entail the trouble of readily fracturing the edges of the stationary cutting blade and the rotary cutting blade and preventing the cable cutter from continuing to be useful thereafter.

The present invention has been developed with the object of effectively solving the problems encountered by the conventional manual cable cutter.

### SUMMARY OF THE INVENTION

The invention provides a manual cable cutter comprising a pair of handles linked to each other in upper parts thereof with two frame plates, one of the pair of handles being adapted as a stationary handle and the other as a rocking handle; a stationary cutting blade having a basal terminal part fixed, with soft bolts capable of being sheared, onto one of the two frame plates in a state superposed on the one frame plate; a rotary cutting blade furnished on an arcuate outer surface thereof with a continuously formed toothed part and pivotally supported rotatably on the stationary cutting blade; a first energizing spring and a second energizing spring disposed between the two frame plates; and a backstop claw meshed with the toothed part of the rotary cutting blade under pressure of the first energizing spring, and a feed claw meshed with the toothed part of the rotary cutting blade under pressure of the second energizing spring and disposed in an upper part of the rocking handle, the backstop claw and feed claw being disposed in an empty space defined between the two frame plates.

In the manual cutter, the basal terminal part of the stationary cutting blade has an inner surface on which a depressed part is formed, and the depressed part has a bottom on which the one frame plate is superposed.

The first aspect of this invention, unlike the conventional equivalent which has the basal terminal part of a stationary cutting blade fixed in the upper part of a stationary handle through ordinary rigid bolts and nuts, adopts a construction such that a pair of handles are fixed to either of two linked frame plates in a superposed state with soft bolts. Even when this cable cutter is required to cut a cable which happens to have such rigidity as defies the cutting ability of the cable cutter itself, therefore, it no longer encounters the trouble inherent in the conventional equivalent that the edges of the stationary cutting blade and the rotary cutting blade are fractured and the cable cutter itself is prevented from continuing to be useful in the future because the soft bolts succumb to shearing by discharging their own role like a safety valve. Further, since the soft bolts which are capable of being sheared are so inexpensive as to permit ready replacement with new supplies without any heavy economic burden, they constitute an immense economic contribution of elongating the service life of the cable cutter itself.

Since the second aspect of this invention, besides satisfying the first aspect of the invention, further comprises a depressed part formed on the inner surface of the basal terminal part of the stationary cutting blade, the bottom of the depressed part being overlaid with one of the frame plates, it not only makes a contribution to the miniaturization of manual cable cutter as a matter of course but also particularly exalts the efficiency with which the soft bolts are sheared.

### BRIEF DESCRIPTION OF THE DRAWINGS

FIG. 1 is a front view illustrating a manual cable cutter according to one embodiment of this invention.

FIG. 2 is a rear view of the same manual cable cutter.

FIG. 3 is a side view of the same manual cable cutter.

FIG. 4 is an exploded perspective view of the essential part of the construction of the same manual cable cutter.

FIG. 5 is a front view of the essential part illustrated in the state assumed by removing a frame plate on the front surface side.

FIG. 6 is a front view of the essential part illustrated in the state assumed by retracting a backstop claw and a feed claw from the outer toothed part of the rotary cutting blade, with the frame plate on the front surface side removed to reveal the interior to advantage.

FIG. 7 is a front view of the essential part illustrated in the state having an empty space defined between the stationary cutting blade and the rotary cutting blade.

### DETAILED DESCRIPTION OF THE INVENTION

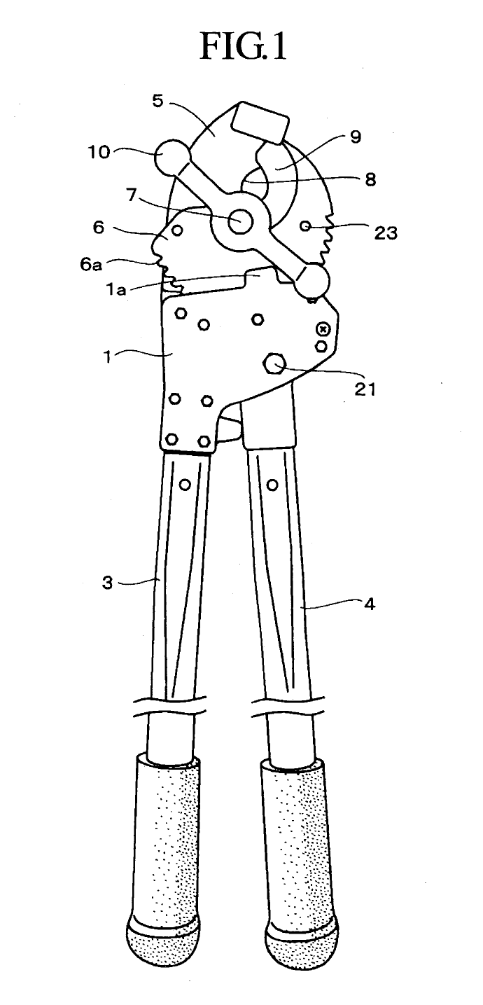

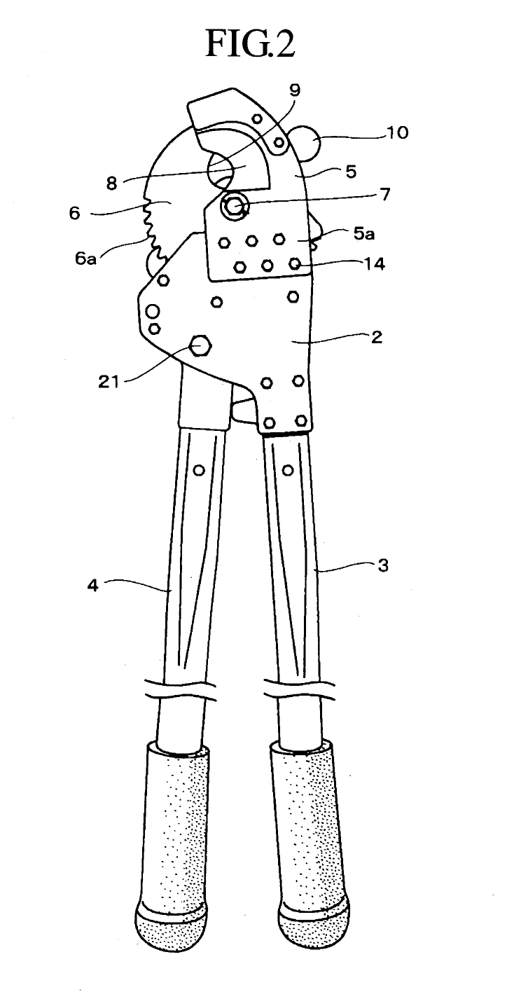

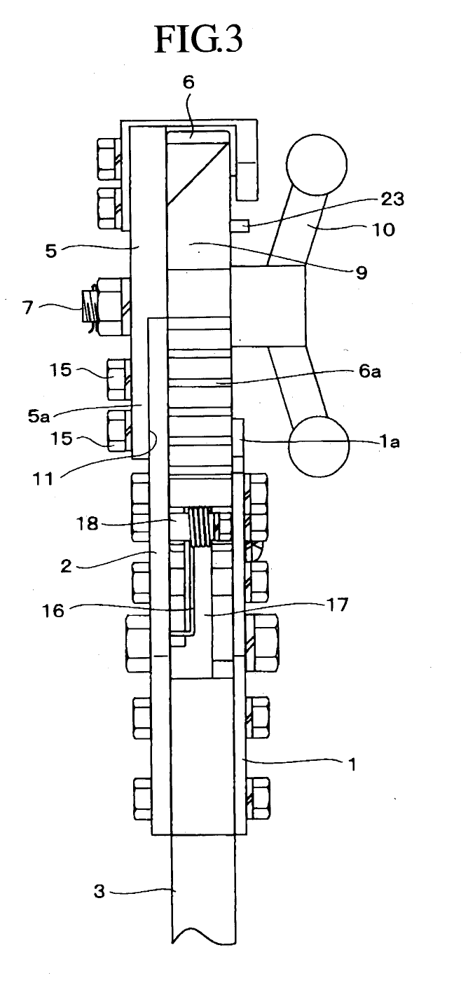

Now, this invention will be described specifically below with reference to the preferred embodiment illustrated herein. The manual cable cutter according to the embodiment, as illustrated in FIG. 1 to FIG. 3, is so constructed as to be provided with a pair of handles 3 and 4 linked to each other in the upper parts thereof with two frame plates 1 and 2, a front one and a rear one, one of the two handles adapted as a stationary handle 3 and the other as a rocking handle 4, a stationary cutting blade 5 fixed at the basal terminal part thereof through bolts and nuts on the side of the frame plate 2 fixed to the stationary handle 3 on the rear surface side, the stationary cutting blade 5 allowing a rotary cutting blade 6 having a toothed part 6a continuously formed on the arcuate outer surface thereof to be pivotally supported rotatably in the central part thereof through an arbor 7, and the rotary cutting blade 6 and the stationary cutting blade 5 serving to hold a given cable in an enclosed state and cut it with a pressing blade part 9 and a receiving blade part 8 formed on the opposed inner edges of the cutting blades 5 and 6. The arbor which pivotally supports the rotary cutting blade 6 on the stationary cutting blade 5 is provided with a thumb nut 10 for rotating the rotary cutting blade 6 in its free state.

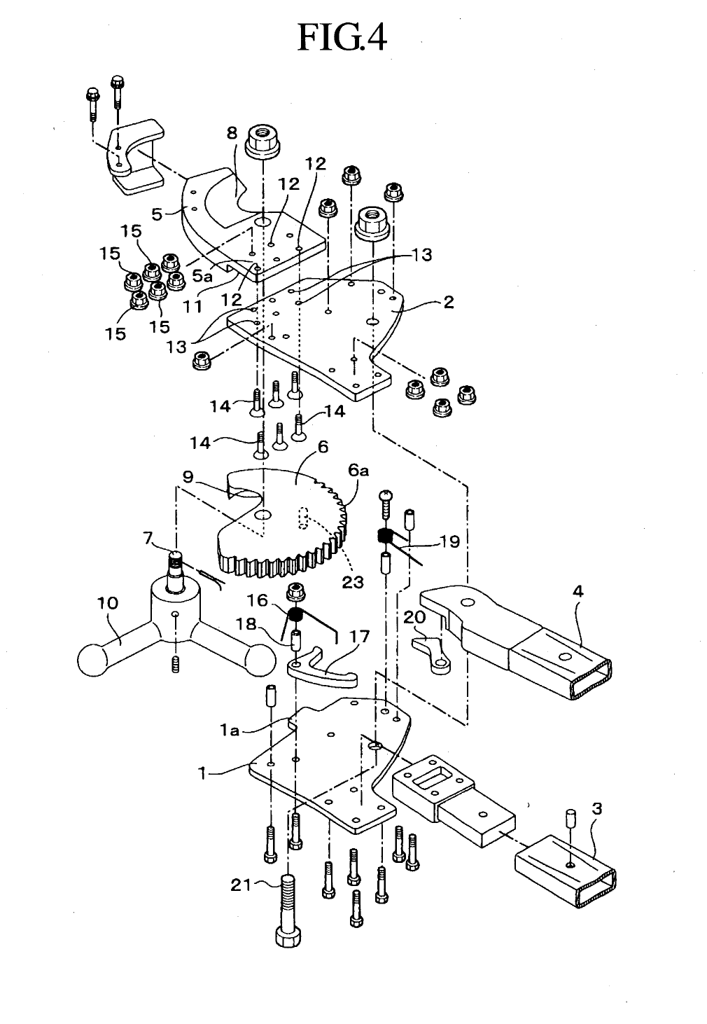

The fixation of a large-width basal terminal part 5a of the stationary cutting blade 5 to the corresponding frame plate 2 on the rear surface side is accomplished by forming a depressed part 11 on the inner surface of the basal terminal part 5a of the stationary cutting blade 5, boring a plurality of bolt-inserting holes 12 through the part of the basal terminal part 5a forming the depressed part 11, and boring bolt-inserting holes 13 corresponding to the bolt-inserting holes 12 in the upper part of the frame plate 2 as illustrated in FIG. 4, posing the frame plate 2 in the depressed part 11 while keeping the two sets of bolt-inserting holes 12 and 13 in a registered state, inserting soft bolts 14 formed such as of a low-carbon steel and enabled to be sheared through the conforming bolt-inserting holes 12 and 13 from the rear side, and clamping the leading terminal parts of the soft bolts 14 protruding from the large-width basal terminal part 5a of the stationary cutting blade 5 with ordinary rigid nuts 15, thereby fixing the basal terminal part 5a of the stationary cutting blade 5 to the frame plate 2.

In the present embodiment, therefore, when the stationary cutting blade 5 is exposed to a large load unexpectedly, the soft bolts 14 undergo shearing and consequently cancel the state of fixation thereof to the frame plate 2 by fulfilling their own role like a safety valve. Even when the rotary cutting blade 6 mechanically produces a rotary motion, the receiving blade part 8 of the stationary cutting blade 5 and the pressing blade part 9 of the rotary cutting blade 6 can be effectively prevented from being fractured.

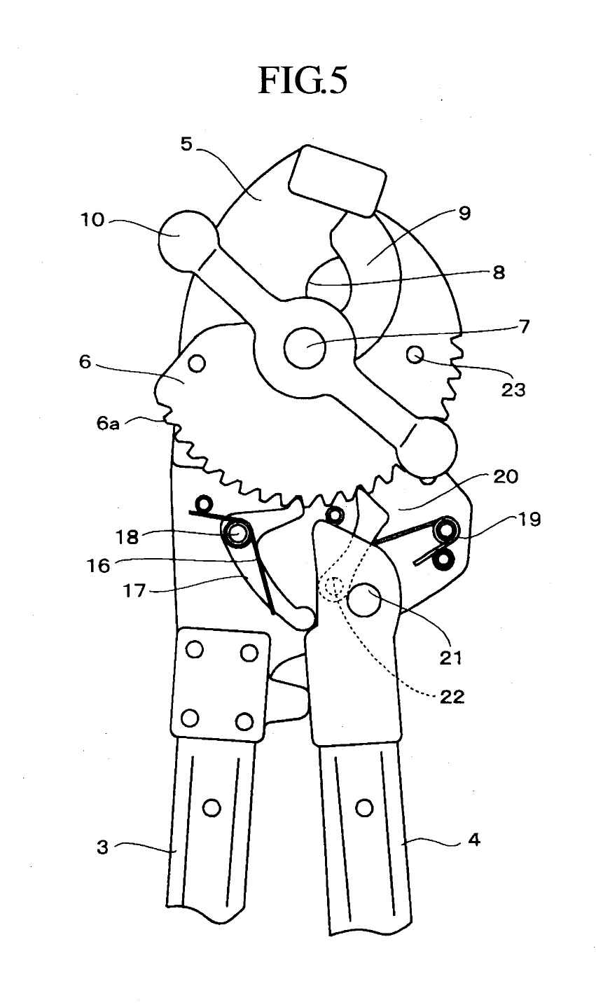

Further, in the empty space defined between the two frame plates 1 and 2, a V-shaped backstop claw 17 meshed with the outer toothed part 6a of the rotary cutting blade 6 is pivotally supported rotatably through an arbor 18 under the energizing pressure of a torsion spring 16 and a feed claw 20 meshed with the outer toothed part 6a of the rotary cutting blade 6 is disposed similarly under the energizing pressure of another torsion spring 19 as illustrated in FIG. 5. This feed claw 20 is required to be disposed rotatably through an arbor 22 in the upper part of the rocking handle 4 which is pivotally supported swingably between the frame plates 1 and 2 through an arbor 21.

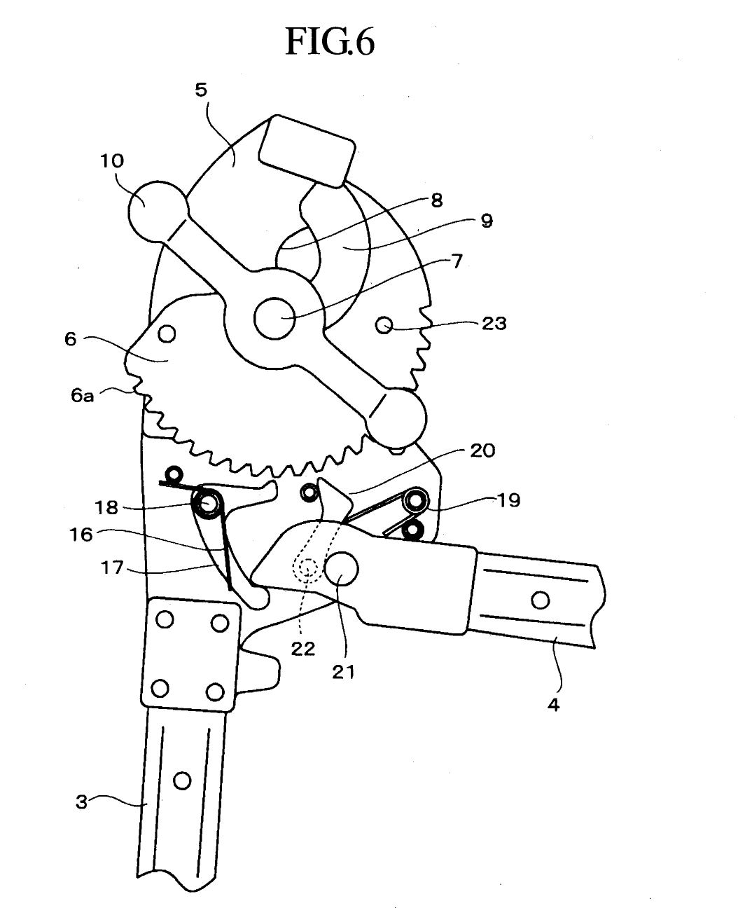

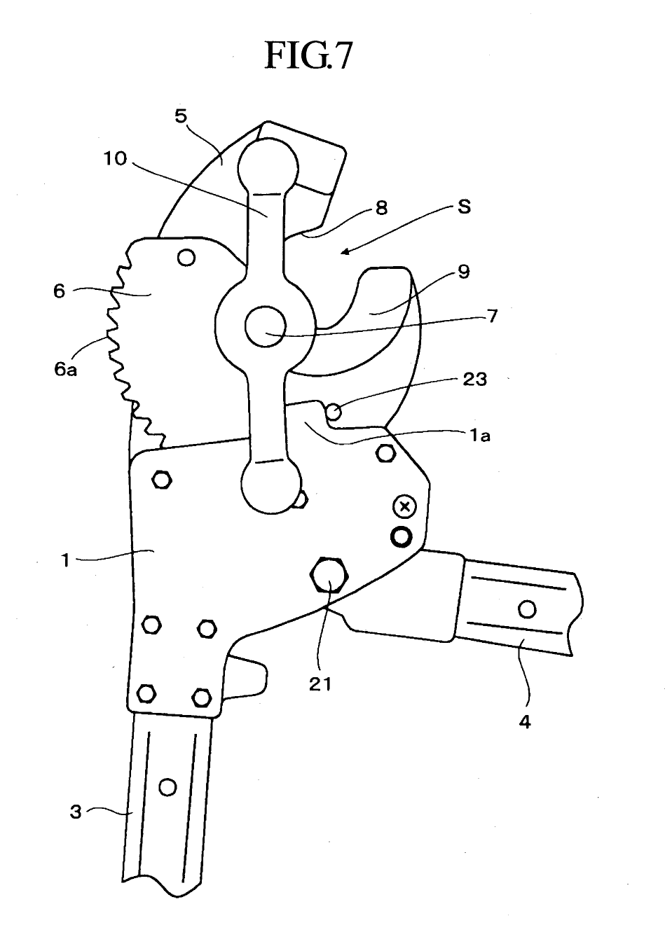

The normal use of the manual cable cutter which is constructed as described above, therefore, is initiated by opening the rocking handle 4 more widely than usual as illustrated in FIG. 6, thereby causing the upper terminal part of the rocking handle 4 to rotate till the backstop claw 17 and the feed claw 20 are retracted from the outer toothed part 6a of the rotary cutting blade 6 in spite of their own energizing pressures. After this state has been assumed, the rotary cutting blade 6 is rotated by means of the thumb nut 10 till a stopper pin 23 furnished for the rotary cutting blade 6 collides against a protruding wall 1a of the frame plate 1 on the front surface side, and the rotary cutting blade 6 and stationary cutting blade 5 are enabled to define an empty space S as illustrated in FIG. 7.

Then, after the state having a cable (not shown) inserted through the empty space S has been assumed, the operator takes hold of the pair of handles 3 and 4 and opens and closes the rocking handle 4 within the normal working range. In response to this operation, the rotary cutting blade 6 produces a rotary motion to nullify the empty space S owing to the idle slide and pushing motion of the feed claw 20 which is meshed with the rotary cutting blade 6 each time the rocking handle is opened and closed and, consequently, the pushing blade part 9 and receiving blade part 8 formed on the opposed edges of the rotary cutting blade 6 and the stationary cutting blade 5 are enabled to cut the cable. During the course of this process, the backstop claw 17 similarly to the conventional equivalent prevents the rotary cutting blade 6 from producing a reverse rotation owning to the idle slide and pushing motion produced by the rotary cutting blade 6 on the outer toothed part 6a.

When the cable cutter while in the normal use mentioned above is required to cut a cable which happens to have such rigidity as defies the cutting ability of the cable cutter itself, it is at first incapable of cutting the cable by the opening-closing operation of the rocking handle 4 similarly to the conventional equivalent. The rotary cutting blade 6 nevertheless continues its rotary motion to nullify the empty space S and eventually press the cable forcibly in the direction of the stationary cutting blade 5.

In the present embodiment of this invention, the stationary cutting blade 5 is fixed to the frame plate 2 with the soft bolts 14 which are capable of being sheared as described above. When the stationary cutting blade 5 is strongly pressed on the rear surface side thereof by the cable in consequence of the mechanical rotary motion of the rotary cutting blade 6, therefore, the plurality of soft bolts 14 serving to fix the basal terminal part 5a of the stationary cutting blade 5 onto the frame plate 2, unlike the conventional equivalents, are easily sheared by discharging their own role like a safety valve and consequently enabled to cancel the state of fixation of the stationary cutting blade 5 on the frame plate 2 and realize efficient absorption of the pressing force produced by the cable. Thus, the service life of the cable cutter itself can be elongated because not only the blade receiving part 8 of the stationary cutting blade 5 but also the pressing blade part 9 of the rotary cutting blade 6 no longer sustains fracture. Further, in this case, the stationary cutting blade 5 is left standing in an unsteady state because the stationary cutting blade 5 and the rotary cutting blade 6 are still maintained in a state of being pivotally supported through the arbor 7.

The soft bolts 14 which have been sheared can be readily replaced with new supplies on account of their inexpensiveness. By refixing the consequently loose stationary cutting blade 5 on the corresponding frame plate 2 with newly supplied soft bolts 14, therefore, it is made possible to render the crippled cable cutter perfectly serviceable again. Thus, the cable cutter of this invention proves very economical as compared with the conventional equivalent.

Owing to the adoption of the construction described above, the first aspect of this invention, unlike the conventional equivalent which fixes the basal terminal part of the stationary cutting blade in the upper part of the stationary handle through ordinary rigid bolts and nuts, enables the pair of handles to be fixed in a superposed state on either of the linked frame plates with soft bolts. Even when the stationary cutting blade is strongly pressed on the rear surface side thereof as when the cable cutter is required to cut a cable which happens to have such rigidity as defines the cutting ability of the cable cutter itself, therefore, the soft bolts are enabled to be sheared by discharging their own role like a safety valve. Even when the blade parts of the stationary cutting blade and the rotary cutting blade sustain fracture as experienced heretofore, it never happens that the cable cutter of this invention itself will become unserviceable thereafter. Moreover, since the soft bolts which are capable of being sheared are so inexpensive as to permit ready replacement, the cable cutter itself enjoys an addition to the service life thereof and proves economical.

The second aspect of this invention, besides satisfying the first aspect of the invention, further comprises a depressed part formed on the inner surface side of the basal terminal part of the stationary cutting blade, and the depressed part has a bottom overlaid with one of the frame plates. Thus, it not only makes a contribution to the miniaturization of manual cable cutter as a matter of course but also particularly exalts the efficiency with which the soft bolts are sheared.

What is claimed is:

1. A manual cable cutter comprising:
a pair of handles linked to each other in upper parts thereof with two frame plates, one of said pair of handles being adapted as a stationary handle and the other as a rocking handle;
a stationary cutting blade having a basal terminal part fixed, with soft bolts capable of being sheared, onto one of said two frame plates in a state superposed on the one frame plate;
a rotary cutting blade furnished on an arcuate outer surface thereof with a continuously formed toothed part and pivotally supported rotatably on said stationary cutting blade;
a first energizing spring and a second energizing spring disposed between said two frame plates; and
a backstop claw meshed with the toothed part of said rotary cutting blade under pressure of said first energizing spring, and a feed claw meshed with the toothed part of said rotary cutting blade under pressure of said second energizing spring and disposed in an upper part of said rocking handle, said backstop claw and said feed claw both being disposed in an empty space defined between said two frame plates;
whereby the soft bolts succumb to shearing without fracturing the stationary cutting blade and the rotary cutting blade when the cable cutter is required to cut a cable which happens to have rigidity high enough to defy a cutting ability of the cable cutter and permit ready replacement with new supplies.

2. The manual cable cutter according to claim 1, wherein the basal terminal part of said stationary cutting blade has an inner surface on which a depressed part is formed, and said depressed part has a bottom on which the one frame plate is superposed.
